(19) United States
(12) Patent Application Publication
(10) Pub. No.: US 2012/0049134 A1
(43) Pub. Date: Mar. 1, 2012

(54) Material for Manufacturing Targets for Physical Vapor Deposition of P-Type Transparent Conductive Films

(76) Inventors: Guido Huyberechts, Steenokkerzeel (BE); Griet Dress, Mol (BE); Daan Goedeme, Herentals (BE); Michael Nolan, Co. Cork (IE); Simon D. Elliott, Co. Cork (IE)

(21) Appl. No.: 13/133,170

(22) PCT Filed: Nov. 30, 2009
(86) PCT No.: PCT/EP2009/008508

§ 371 Date: Nov. 1, 2011

(30) Foreign Application Priority Data
Dec. 8, 2008 (EP) 08021258.2
Dec. 18, 2008 (US) 61193714

(51) Int. Cl. H01B 1/00

(52) U.S. Cl. 252/519.1

(57) ABSTRACT

The invention describes a powderous oxide material (MₓM′_{y})Cu₂₊ₐ O_{2+b} for the production of targets for p-type transparent conductive thin films, wherein −0.2≦a≦0.2, −0.2≦b≦0.2 and either —M′ is Sr and M is either one or both of Ba and bivalent Cu, with x>0, y>0 and x+y=1 ±0.2; or —M is bivalent Cu, x=1 ±0.2, and y=0.

This invention relates to material compositions, a manufacturing method for these materials and a manufacturing method for ceramic bodies, to be used as so-called targets in physical vapour deposition techniques of p-type transparent conductive films.

During the last decades, a significant advance has been made in the development of transparent conductive oxides. ITO, indium tin oxide, has the lowest resistivity obtained thus far for n-type transparent conductive oxides and combines a resistivity of −10⁻⁴ Ωcm with a transparency of up to 80-90% over the visible-NIR spectral range. Aluminium doped zinc oxide, ZnO:Al, has been suggested, and is used in a number of applications, as alternative to ITO but its performance is still somewhat inferior to that of ITO (resistivity >10⁻⁴ Ωcm). All the transparent conductive oxides showing resistivities in this order of magnitude however are n-type conductive oxides.

Hence, despite their excellent characteristics, their application is merely limited to applications where transparent conductive electrodes are required, such as light emitting devices, flat panel displays, photovoltaic devices, smart windows, etc. In order to allow the construction of novel type of electro-optic devices there is the need for p-type transparent conductive oxides as well. The availability of high quality p-type transparent conductive oxides would allow the combination of these materials with existing n-type materials into transparent active devices, by the formation of p-n junctions and allowing the manufacturing of transparent transistors. This allows the formation of UV light emitting diodes (resulting for example in novel display types if combined with phosphors, transparent electronic circuits, sensors, . . . ). This observation has been made by a number of researchers and inventors in the past and has resulted in a substantial amount of research towards the development of transparent conductive p-type materials.

However, the p-type transparent conductive oxides identified to date have resistivities that are at least one order of magnitude higher than their n-type counterparts and typically need high temperatures for the formation of thin films. Examples can be found in H. Kawazoe et al., P-type electrical conduction in transparent thin films of CuAlO₂, Nature, 389, 939-942 (1997); and H. Mizoguchi, et. al, Appl. Phys. Lett., 80, 1207-1209 (2002), H. Ohta, et al, Solid-State Electronics, 47, 2261-2267 (2003), both dealing with AMO₂ configuration materials, where A is the cation and M is the positive ion, for example CuAlO₂.

Despite the poor performance of these p-type transparent conductive oxides known to date, a number of studies on the formation of transparent p-n junctions has already been reported, such as transparent diodes based on p-n homojunctions (CuInO₂) in K. Tonooka, et al, Thin Solid Films, 445, 327, (2003); and opto-electronic devices utilising p-n heterojunctions (p-SrCu₂O₂/n-ZnO), in H. Hosono, et al, Vacuum, 66, 419 (2002). Other materials are p-ZnRh₂O₄/n-ZnO UV-LEDs, p-NiO/n-ZnO UV detectors, UV-detector based on pn-heterojunction diode composed of transparent oxide semiconductors, such as p-NiO/n-ZnO, and p-CuAlO₂/n-ZnO photovoltaic cells and transparent electronics.

However, the performance of these diodes was poor due to poor material quality, non-optimum resistivity and carrier concentration of the p-type transparent conductive oxides or not abrupt interfaces of the heterojunctions, thus, giving ideality factors not less than 1.5, forward current to reverse current ratios between 10 and 80 for V<□4V, breakdown voltage less than 8 Volts, increased series resistance and turn-on-voltage not corresponding always to the band gap of the materials. The transparency of these devices was between 40% and 80%.

Work by the groups of Kawazoe and Hosono (e.g. in H. Yanagi et al., J. Electroceram., 4, 407 (2000)) has led to the description of a number of p-type transparent conductive oxides based on Cu(I) bearing oxides. A UV-emitting diode based on p-n heterojunction composed of p-SrCu₂O₂ and n-ZnO was successfully fabricated by heteroepitaxial thin film growth, as reported in H. Ohta, et al., Electron. Lett., 36, 984 (2000).

Among these p-TCO materials, SrCu₂O₂ (also referred to as SCO) is one of the most promising candidates for use in optoelectronic devices, mainly because the epitaxial films can be obtained at relatively low temperatures to prevent interface reactions in the junction region. Although synthesis of nondoped and K-doped SrCu₂O₂ thin films has been reported, e.g. in U.S. Pat. No. 6,294,274 B1, the effects of dopant on the optoelectronic property of SrCu₂O₂ are not yet fully understood and the conduction of SrCu₂O₂ films has up to now been smaller than that of the other p-type TCOs. K-doped SCO has the disadvantage of incorporating a small ionic radius element in the structure, which, due to its high mobility, is not appropriate in electronic applications in combination with n-type materials (in diodes, transistors, opto-electronic components, . . . ). Nie et at (in Physical Review B, Vol.65 (2002), 075111) have predicted that adding a small amount of Ca into SrCu₂O₂ can increase the band gap and reduce the hole effective mass of SrCu₂O₂, and therefore increase the transparency and conductivity. Nie also gives ab initio calculations of the electronic properties of BaCu₂O₂, however, in practical tests it has been shown that targets made out of this material desintegrate to powder by the over time formation of Ba- and Cu-oxides, possible initiated by air humidity. This phenomenom has also been observed in the production of sputtering targets for superconductor applications (“YBCO” targets). Furthermore Nie projects that both MgCu₂O₂ and CaCu₂O₂ are promising materials, but have yet to be synthesized. Indeed it seems difficult, not to say impossible, to provide pure MgCu₂O₂ or CaCu₂O₂. In U.S. Pat. No. 7,087,526 CaO doped SCO thin films have been disclosed. In Semicond. Sci. Technol. 21 (2006) 586-590, Sheng et al. disclose a method of preparing p-type transparent conducting Ca-doped SrCu₂O₂ thin films deposited on a quartz glass substrate, by a pulsed laser deposition technique. In U.S. Pat. No. 6,294,274 K-doped SrCu₂O₂ thin films are disclosed.

It is an aim of this invention to propose p-type transparent conductive oxides that have much lower resistivities than reported before, and that can be formed into durable targets and thin films.

This problem is solved by providing for a powderous oxide material (MₓM′_{y})Cu₂₊ₐO_{2+b} for the production of targets for p-type transparent conductive thin films, wherein
−0.2≦a≦0.2, −0.2≦b≦0.2, and either
M′ is Sr and M is either one or both of Ba and bivalent Cu, with x>0, y>0 and x+y=1±0.2; or
M is bivalent Cu, x=1±0.2, and y=0.
Preferably M′=Sr and M=Ba. Also, preferably 0<x<0.20, and even 0.020.06.

This powderous oxide material (MₓM′_{y})Cu₂₊ₐO_{2+b} can be used in the production of targets for p-type transparent conductive thin films.

The innovative materials contain copper (in monovalent state) and oxygen and one or more bivalent additional elements, M and NV, as described above. The composition of the materials is preferentially within the elemental composition range ((M+M):Cu:O=1.0±0.2:2.0±0.2:2.0±0.2). Preferably the composition contains at least 95% of the material.

The invention will be illustrated with the following Figures:

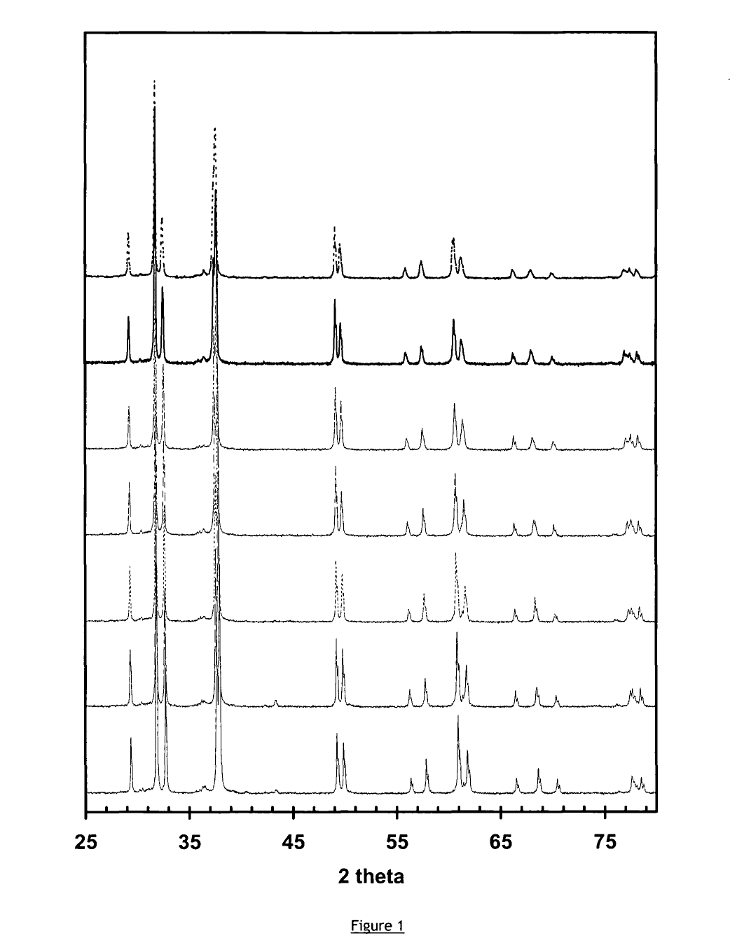

FIG. 1: X-ray diffraction patterns of doped SCO

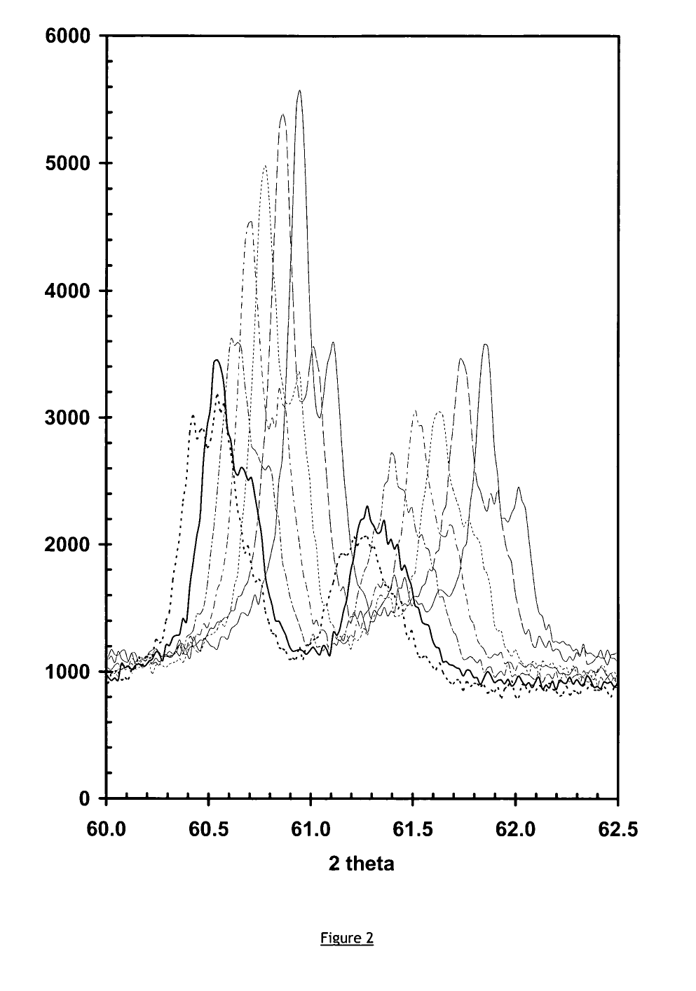

FIG. 2: Detail of X-ray diffraction pattern of doped SCO showing peak shift vs. concentration

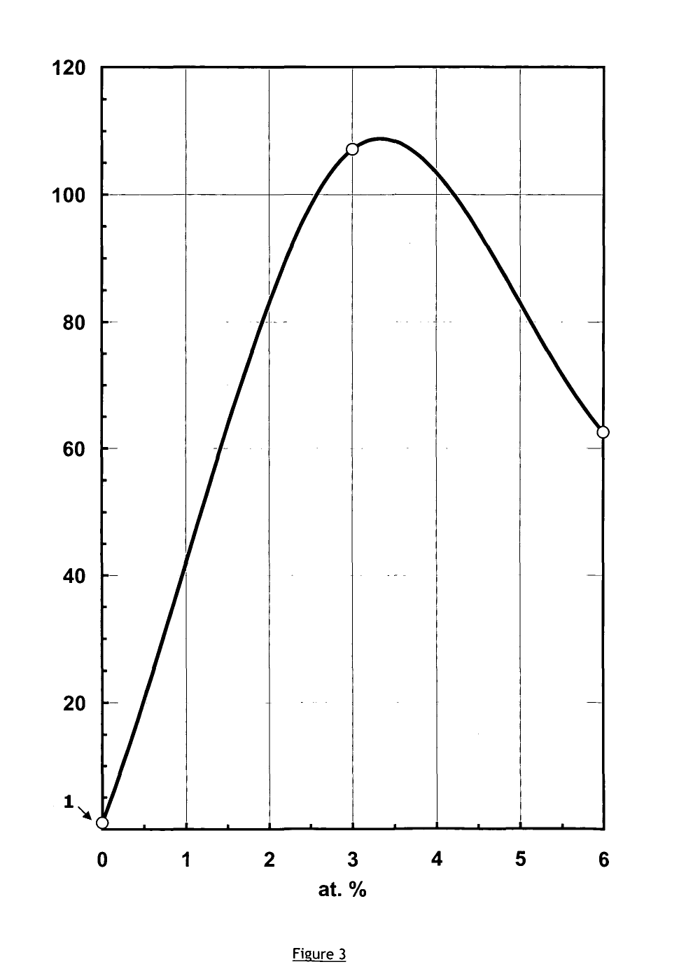

FIG. 3: Normalised conductivity of thin films deposited by PLD from doped SCO targets

The copper oxide powders are manufactured using known methods, one of which is preferred and is detailed below for a (BaₓSr_{y})Cu₂O₂composition according to the invention: the basic procedure is to start from Cu₂O (purity of 99.5% or better) and Sr(OH)₂ and Ba(OH)₂. A mixture is made, taking into account crystal water and raw material composition, containing matter in the ratio x mol Ba, y mol Sr and 2 mol Cu. (see Table 1 below)

The well mixed mixture is passed through a Retsch ZM100 centrifugal mill for homogenisation. The resulting powder is heat treated for 40 h under nitrogen flow at 950° C.

This method yields a substitution of strontium atoms without phase separation as becomes clear from the X-ray diffraction pattern in FIG. 1 (counts vs. 2θ), for the different compositions of Table 1, where Composition No. 1 (reference material without Ba) is represented by the bottom pattern, and consequently Comp. No. 2-7 from below to the top of the Figure.

The following Table summarizes the observations made for the synthesized materials of the kind (BaₓSr_{y})Cu₂O₂. The material with x=0 is included for reference only (state-of-the-art reference material).

TABLE 1

| Compostion | x | y | | Identified |
|---|---|---|---|---|
| N° | (Ba) | (Sr) | Code | major phase |
| 1 | 0.00 | 1.00 | 100:0 | Cu₂SrO₂ |
| (reference) | | | | |
| 2 | 0.03 | 0.97 | 97:3 | Cu₂SrO₂ |
| 3 | 0.06 | 0.94 | 94:6 | Cu₂SrO₂ |
| 4 | 0.09 | 0.91 | 91:9 | Cu₂SrO₂ |
| 5 | 0.12 | 0.88 | 88:12 | Cu₂SrO₂ |
| 6 | 0.15 | 0.85 | 85:15 | Cu₂SrO₂ |
| 7 | 0.18 | 0.82 | 82:18 | Cu₂SrO₂ |

All the compositions show a SrCu₂O₂-like majority phase, with a peak shift related to the amount of strontium replacement by barium, as observed in a detail of the X-ray diffractogram shown in FIG. 2 (showing counts against 2θ). In FIG. 2, from left to right are shown the curves for the Compositions No. 1-7 of Table 1. There are no signs of separation of a specific barium compound, indicating effective doping of the material with Ba. Copper is present in its first oxidation state Cu(I).

From the materials according to the invention targets are made by known methods. A preferred method is hot pressing. Other methods are green body formation (by slip casting, cold isostatic pressing, cold uniaxial pressing and other techniques known) followed by sintering and/or hot isostatic pressing and or spark plasma sintering and the like.

In an example, 22.0 gram of material is compacted in graphite molds of 30 mm diameter. The powder is cold (pre-)pressed at 20 kN, heated at 50° C./min with a minimal load of 4 kN (below 640° C. no temperature registration is possible, full power heating is used). At a temperature of 900° C., the load is increased from 4 to 10 kN, at 975° C. the load is increased from 10 to 20 kN. This load is kept constant for 30 min at 975° C. and followed by natural cooling of the sample.

The hot pressed samples are polished to remove the interface layer formed during the compaction process. The material synthesised has a high level of phase purity, resulting in a single phase (or quasi single phase) target, which is considered as advantageous for PVD applications.

### The Target Manufacturing Process can be Summarized as Follows:

Weigh Cu₂O, Sr(OH)₂.8H₂O and Ba(OH)₂.8H₂O=>
Mix ingredients =>
Dry ingredients under vacuum at 80-90° C. for 4 days=>
Mix and mill in a Retsch ZM100 centrifugal mill to 80 μm=>
React in furnace under nitrogen at 950° C. during 40 h=>
Mix and mill in a Retsch ZM100 centrifugal mill to 250 μm=>
Mix and mill in a Retsch ZM100 centrifugal mill to 80 μm=>
Package and seal=>
Apply compaction, cold pressing=>
Heat up to and hold at 975° C.=>
Cool down=>
Grind and polish.

Unlike in the case of BaCu₂O₂ targets, as mentioned above, the BaSCO targets do not desintegrate by individual oxide formation. Also thin films made with these targets, being even more vulnerable due to their low thickness, do not deteriorate over time. For producing the conductive thin films several methods can be used, such as sputtering and/or ablation (including but not limited to pulsed laser deposition, PIAD, evaporation and other techniques known in the state of the art and relying on powder or bodies for the deposition of thin films), where the bodies can be in planar, tubular or rod shapes or any form suited for a specific deposition tool and application. Thin films made with a composition according to the invention behave as a p-type transparent conducting oxide.

A set of experiments under indentical deposition and annealing conditions are carried out with full electrical characterisation of materials with different doping levels, using targets as prepared above. In the Table below thin film samples TF 171, 172 and 176 are according to the invention, whilst TF 173 is a film made of pure SrCu₂O₂ of the prior art. All films were obtained by pulsed laser deposition. The resistivity of the films is measured with a Van der Pauw configuration, and the carrier type and carrier mobility is determined by Hall measurements at room temperature (contact metal: Gold), the results are given in Table 2. The film transparancy was excellent.

TABLE 2

| | | Film | | | | |
|---|---|---|---|---|---|---|
| | | thickness | Resistivity | Carriers | Mobility | |
| Sample | Composition | (nm) | (Ohm · cm) | (p-type) | (cm²/Vs) | Annealing |
| TF173 | SrCu₂O₂ | 150 | 7.5 × 10³ | 5.32 × 10¹² | 156 | RT |
| TF172 | (Ba_{0.03}Sr_{0.97})Cu₂O₂ | 225 | 7.0 × 10¹ | 1.28 × 10¹⁵ | 70 | RT |
| TF171 | (Ba_{0.06}Sr_{0.94})Cu₂O₂ | 220 | 1.2 × 10² | 1.38 × 10¹⁵ | 3.8 | RT |
| TF176 | (Ba_{0.06}Sr_{0.94})Cu₂O₂ | 145 | 4.9 × 10² | 4 × 10¹⁶ | 0.3 | in situ |

RT: room temperature

The Table shows the superior properties of slightly Ba-doped SCO. In FIG. 3 the conductivity normalised to pure SCO (=1) is given against the Ba content (in at. %), with a best fit line. It can be concluded that the best results are obtained for (BaₓSr_{y})Cu₂O₂ with 0.02≦x≦0.06.

1-5. (canceled)

6. A powderous oxide material (MₓM′_{y})Cu₂₊ₐO_{2+b} for the production of targets for p-type transparent conductive thin films, wherein −0.2≦a≦0.2, −0.2≦b≦0.2, and either
—M′ is Sr and M is either one or both of Ba and bivalent Cu, with x>0, y>0 and x+y=1±0.2; or
—M is bivalent Cu, x=1±0.2, and y=0.

7. The powderous oxide material of claim 6, wherein y>0, M′=Sr, and M=Ba.

8. The powderous oxide material of claim 7, wherein 0<x<0.20.

9. The powderous oxide material of claim 8, wherein 0.02≦x≦0.06.

10. A method of producing targets for p-type transparent conductive thin films comprising employing the powderous oxide material (MₓM′_{y})Cu₂₊ₐO_{2+b} of claim 6.
